(19) United States
(12) Patent Application Publication
(10) Pub. No.: US 2022/0134699 A1
(43) Pub. Date: May 5, 2022

(54) POWERED SEPARATOR GAP CONTROL

(71) Applicant: Thomas Precision Machining, Inc., Rice Lake, WI (US)

(72) Inventors: Kevin Nyara, Luck, WI (US); Jordan Hafstad, Rice Lake, WI (US); Gary Novak, Chetek, WI (US)

(21) Appl. No.: 17/647,750

(22) Filed: Jan. 12, 2022

Related U.S. Application Data
(63) Continuation-in-part of application No. 16/943,089, filed on Jul. 30, 2020.
(60) Provisional application No. 62/880,978, filed on Jul. 31, 2019.

(51) Int. Cl. B30B 9/12; B30B 9/18

(52) U.S. Cl. CPC B30B 9/121; B30B 9/18; B30B 9/125

(57) ABSTRACT

An adjustment assembly for adjusting a gap between a restrictor ring and an auger in an industrial food separator is provided. The adjustment assembly includes an electric motor and a mechanical assembly coupling the electric motor to the restrictor ring. The adjustment assembly is configured to translate rotation of a shaft of the electric motor into movement of the restrictor ring to change a width of the gap. A controller coupled to the electric motor. The controller having one or more processing devices, a memory coupled to the one or more processing devices, and storage media. The storage media has instructions stored thereon, the instructions, when executed by the one or more processing devices, cause the one or more processing devices to send commands to the electric motor to move the restrictor ring to change a width of the gap.

### RELATED APPLICATIONS

This application is a continuation-in-part of U.S. patent application Ser. No. 16/943,089, entitled “POWERED SEPARATED GAP CONTROL”, which claims the benefit of U.S. Provisional Application No. 62/880,978, entitled “POWERED SEPARATOR GAP CONTROL”, both of which are hereby incorporated herein by reference.

### BACKGROUND

Industrial food separators are used in the food processing industry to mechanically separate out food parts with different densities. A common use for a food separator is for separating raw protein from bone and sinew on a carcass after the main cuts of meat have already been removed. Many industrial food separators work by pressing the product against a screen or plate with holes. The apertures in the screen/plate are selected based on the product being processed, such that the softer portions (e.g., meat/protein) of the product can be pressed through the screen/plate leaving the harder/larger portions (e.g., bone and sinew) behind the screen/plate.

One type of separator uses an auger with a tapered shaft to press the product against a cylindrical screen. The auger blades force the product towards a first end thereof and the taper of the auger decreases the space between the auger and the screen as the product is moved towards the first end. The separator defines a restrictive annular gap between the shaft of the auger and the separator frame at the far end of the screen, such that product that remains after the softer portions are pressed through the screen can pass through the gap and be expelled from the separator. The result is two output streams of material that are produced from a single input stream. The first output stream is material that has been pressed through the screen and the other output stream is material exiting through the gap.

Existing separators allow an operator to use an auger with blade pitch and taper as desired and a screen with aperture size and shape as desired to achieve the desired separation yield for the material that is being separated. Existing separators also allow an operator to set the width of the restrictive annular gap to control how much back pressure is placed on the input product stream.

### BRIEF DESCRIPTION

Embodiments for an adjustment assembly for adjusting a gap between a restrictor ring and an auger in an industrial food separator are provided. The adjustment assembly includes an electric motor and a mechanical assembly coupling the electric motor to the restrictor ring. The adjustment assembly is configured to translate rotation of a shaft of the electric motor into movement of the restrictor ring to change a width of the gap. A controller coupled to the electric motor. The controller having one or more processing devices, a memory coupled to the one or more processing devices, and storage media. The storage media has instructions stored thereon, the instructions, when executed by the one or more processing devices, cause the one or more processing devices to send commands to the electric motor to move the restrictor ring to change a width of the gap.

Embodiments for an industrial food separator are also provided. The separator includes a housing defining a separation chamber, which is defined at least in part by a screen. The separator includes an auger extending through the separation chamber and a restrictor ring disposed to define a gap between the restrictor ring and the auger. The auger is configured to force product in the separation chamber against the screen and towards the gap to produce a first output flow of product that has been pressed through the screen and a second output flow of product that passes through the gap. The separator also includes an adjustment assembly configured to move the restrictor ring and adjust a width of the gap. The adjustment assembly includes an electric motor and a mechanical assembly coupling the electric motor to the restrictor ring. The mechanical assembly translates rotation of a shaft of the electric motor into movement of the restrictor ring to change a width of the gap. The separator also includes a controller communicatively coupled to the electric motor. The controller has one or more processing devices, a memory coupled to the one or more processing devices, and storage media. The storage media has instructions stored thereon. The instructions, when executed by the one or more processing devices, cause the one or more processing devices to send commands to the electric motor to move the restrictor ring to change a width of the gap.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a cross-sectional view of an example separator that provides for powered adjustment of a restrictor gap between a restrictor ring and an auger;

FIG. 2A is an enlarged cross-sectional view of a portion of the separator showing the restrictor gap;

FIG. 2B is a cross-sectional view of the separator showing the restrictor ring in the fully closed position;

FIG. 3 is an exploded view of an example powered adjustment assembly to adjust the position of the restrictor ring of FIG. 2;

FIG. 4A is a cross-sectional view of the adjustment assembly of FIG. 3;

FIG. 4B is another cross-sectional view of the adjustment assembly of FIG. 3;

FIG. 5 is a perspective view of the adjustment assembly of FIG. 3;

FIG. 6 is a side view of a portion of the adjustment assembly of FIG. 3;

FIG. 7 is a cross-sectional view of a portion of the adjustment assembly of FIG. 3;

FIG. 8 is a perspective view of the adjustment assembly of FIG. 3 and a portion of the housing and auger of the separator of FIG. 1, showing the adjustment assembly in the open position;

FIG. 9 is a perspective view of the adjustment assembly and portion of the housing and auger of FIG. 8 showing the adjustment assembly in the closed position;

FIG. 10A is a cross-sectional view of an example separator with an example power adjustment assembly;

FIG. 10B is a cross-sectional view of an example separator with another example power adjustment assembly;

FIG. 10C is a perspective view of the power adjustment assembly of FIG. 10B;

FIG. 10D is a cross-sectional view of the power adjustment assembly of FIG. 10B;

FIG. 10E is an exploded view of the power adjustment assembly of FIG. 10B;

FIG. 11 is a cross-sectional view of an example separator with an yet another example power adjustment assembly;

FIG. 12 is a cross-sectional view of an example separator with still another example power adjustment assembly; and

FIG. 13 is a block diagram of an example electric motor and controller for use with an adjustment assembly to move a restrictor ring.

### DETAILED DESCRIPTION

Most existing separators require difficult manual manipulation of the separator in order to change the size of the restrictive annular gap. For example, some separators require an operator to manually turn a nut with a large wrench. The nut is coupled to various threaded elements such that turning the nut moves a restrictor ring that defines one side of the annular gap, with the shaft of the auger defining the other side. By turning the nut the restrictor ring can be moved relative to the auger to increase or decrease the size of the gap. This nut, however, can be very difficult to turn due to friction of the parts within the separator and other factors.

Moreover, it can be difficult to get the gap set at the desired size/width after a rebuild of the separator. Separators are occasionally taken apart to replace the auger, screen, restrictor ring, for cleaning, or for other reasons. Each time the separator is put back together after being taken apart the position of the components can change slightly. Because the components within the separator may be in a slightly different position than prior to being taken apart, the position of the adjustment nut or other adjustment means for the restrictor ring that was used prior to the separator being taken apart may no longer correspond to the same gap that it did before. Accordingly, it is difficult for the operator to know where the adjustment nut should be set before the machine is turned on. Additionally, due to either the physical difficulty of moving the adjustment nut or because adjusting the restrictor ring is unsafe during operation, the separator and any corresponding processing lines may have to be taken down from operation in order to adjust the restrictor ring setting.

One existing separator includes a hydraulically actuated restrictor ring to eliminate the difficulty of manual adjustment. The hydraulically actuated design, however, does not provide for control of the absolute position of the restrictor ring. Instead, the hydraulically actuated design merely adjusts the amount of force placed on the restrictor ring in order to achieve an approximate position during operation. Moreover, because the hydraulic design merely places force on the restrictor ring and relies on counteracting force from product flow to keep the gap open, a separator with the hydraulic design must be started with no pressure on the restrictor ring in order to prevent damage due to contact between the restrictor ring and the auger. With no force on the restrictor ring, however, much of the soft material in the initial portion of product flow escapes through the gap before the force on the restrictor ring reaches its steady state level.

Additionally, since the width of the gap in the hydraulic design is based on the amount of force provided by the product flow, temporary increases in the force of the product flow, due to for example a large hard piece of material, can cause the separator to “burp” and temporarily increase the width of the gap to allow the hard piece of material to pass through the gap. Such burping can allow an amount of soft material, which would have otherwise been pressed through the screen, to escape through the gap during the temporary increase in the size of the gap. Finally, the use of hydraulics in a food processing machine increases the risk of food contamination due to leaking hydraulic fluid.

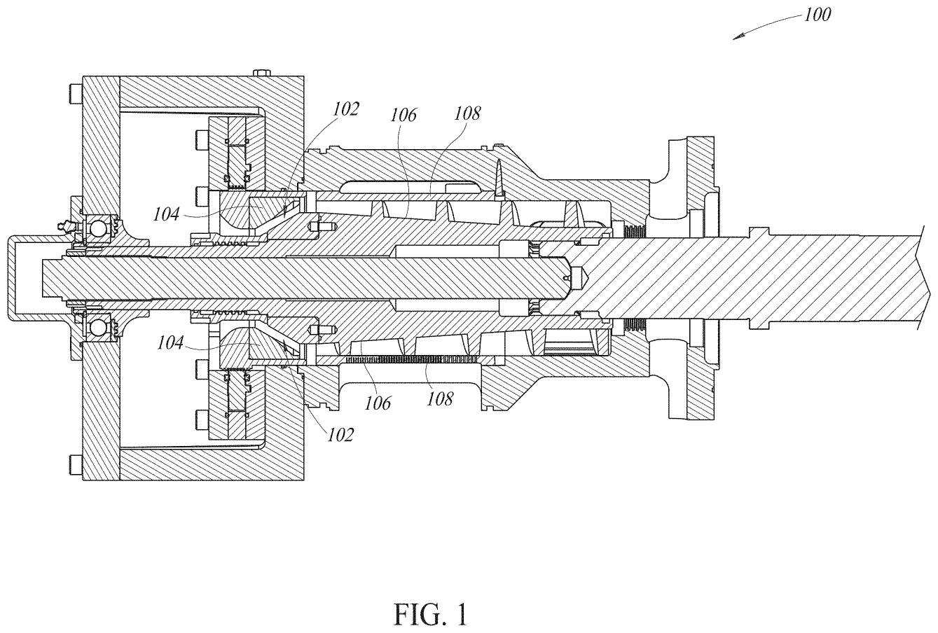

FIG. 1 is a cross-sectional view of an example separator 100 that provides for powered adjustment of a gap 102 defined for an outlet of harder material from a separation chamber 107. Separator 100 includes an auger 106 disposed within a separation chamber 107 that is defined at least in part by a cylindrical screen 108. The screen 108 can have holes of any suitable shape(s) and size(s), such as circular, rectangular, and/or varied sizes across the screen 108. The separator 100 turns the auger 106 to push product from right to left across the page on FIG. 1. Product enters the separation chamber 107 proximate the right side thereof and is pushed across the chamber 107 by the auger 106. The separation chamber 107 can have a cylindrical geometry with the outer circumference defined at least in part by the cylindrical screen 108. The auger 106 extends through the center of the chamber 107 and the product flows through the annular space between the auger 106 and a cylindrical screen 108. The blades of the auger 106 push the product from the right side of the separation chamber towards the left side thereof. The annular space between the shaft of the auger 106 and the screen 108 decreases from right to left, which forces the product flow against the screen 108. Softer portions of the product are pressed through the screen 108, while harder portions that are not pressed through the screen 108 exit out though the gap 102. In the example shown in FIG. 1, the gap 102 is defined between the restrictor ring 108 and the shaft of the auger 106. The separator 100 can be configured to operate on any suitable product including animal parts, shellfish, fruits, or vegetables between a restrictor ring 104 and a shaft of an auger 106. In other examples, the separator 100 is configured to extract oil from seeds or plants for industrial, cosmetic, or pharmaceutical uses, such a biodiesel or hemp oil. In yet other examples, the separator 100 is configured for dewatering of slurries, that is, to reduce the water content of a material flow as can be used in the production of ethanol or wastewater processing, among other things.

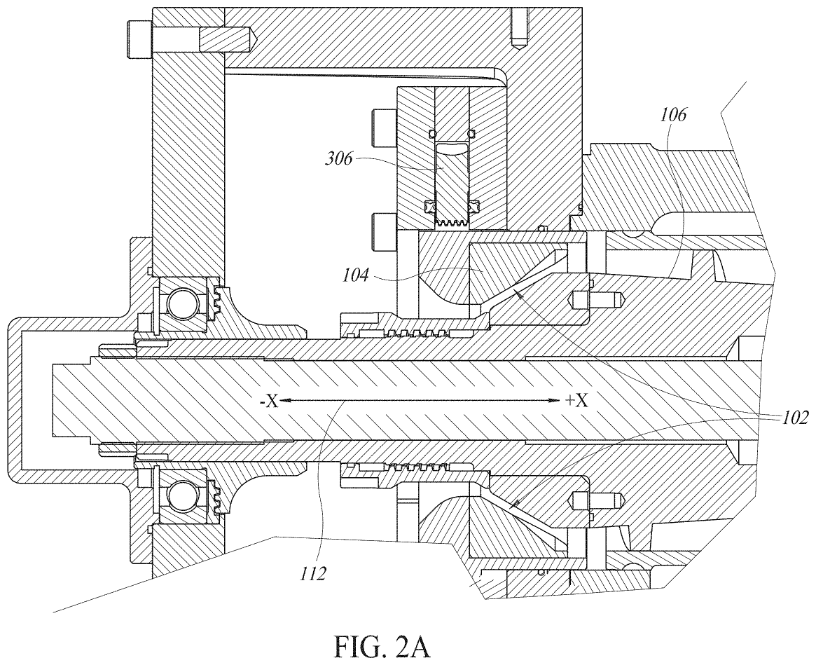

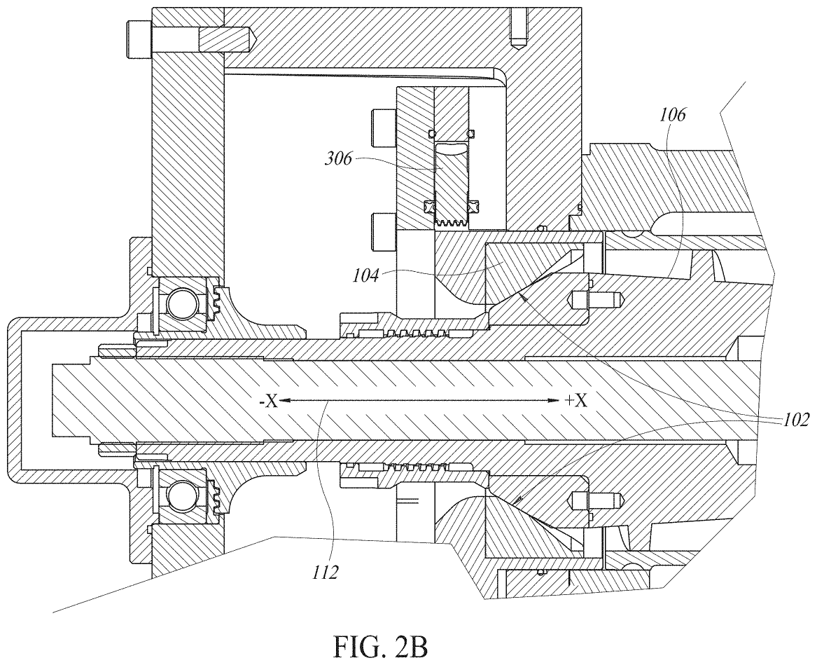

FIG. 2A is an enlarged cross-sectional view of a portion of the separator 100 showing the gap 102 and components nearby. As discussed above, the gap 102 is defined between the restrictor ring 104 (ring valve assembly) and the auger 106. The restrictor ring 104 is an annular structure that is aligned concentrically with the shaft of the auger 106. The restrictor ring 104 defines an annular surface that opposes an outer surface of the auger 106. The outer surface of the auger 106 is that opposes the restrictor ring 104 is often referred to as the nose cone. The space between the nose cone of the auger 106 and the restrictor ring 104 defines the gap 102 through which the harder product flow exits the separation chamber 107.

The gap 102 between the restrictor ring 104 and the auger 106 can be adjusted to increase or decrease the backpressure on the product flow within the separation chamber 107. The gap 102 is adjusted by moving the restrictor ring 104 relative to the auger 106. In particular, the gap 102 is adjusted by moving the restrictor ring 104 forward or backward in a direction parallel with the axis of rotation 112 of the auger 106. In the view shown in FIG. 2A, this direction of movement for the restrictor ring 104 corresponds to left and right (−X, +X) on the page. FIG. 2A illustrates the restrictor ring 104 in an example fully open position.

FIG. 2B is a cross-sectional view of the separator 100 showing the restrictor ring 104 in the fully closed position. In an example, the restrictor ring 104 can be positioned anywhere from the fully closed position to the fully open position during operation of the separator 100. The auger 106 and restrictor ring 104 can have any suitable composition, such as metal with ceramic wear plates facing inward within the gap 102.

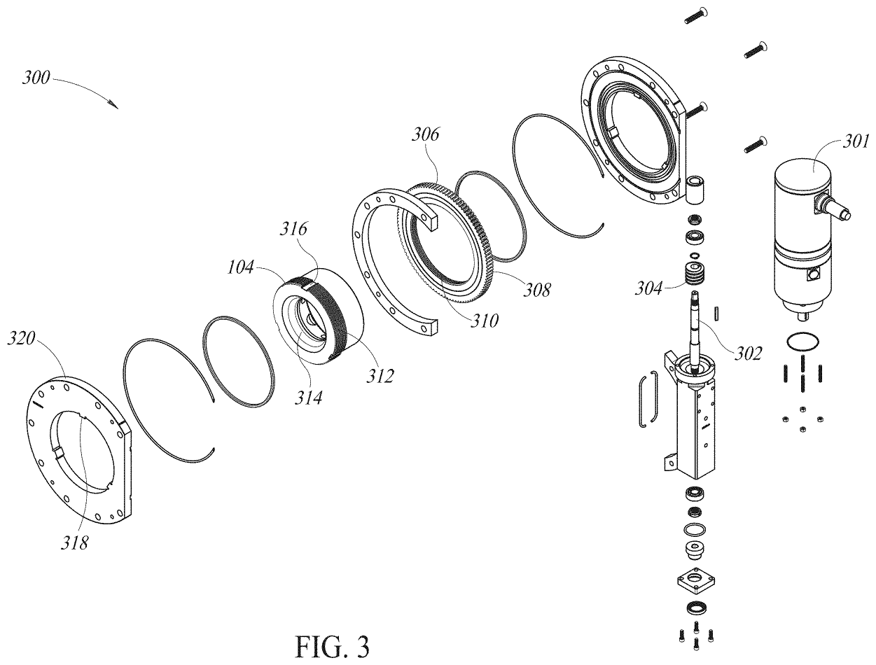

FIG. 3 is an exploded view of an example powered adjustment assembly 300 to adjust the position of the restrictor ring 104. The powered adjustment assembly 300 is an assembly of components that includes the restrictor ring 104, an electric motor 301, and coupling components which transfer power from the electric motor 301 to the restrictor ring 104 to move the restrictor ring 104 and adjust the width of the gap 102.

The electric motor 301 can have any suitable power and speed and be any suitable type of motor such as an AC or DC powered motor, a servo motor, a stepper motor, a synchronous, or asynchronous motor. The electric motor 301 can have any suitable feedback device, either separate or integrated, such as a rotary encoder, a linear encoder, or position-indicating switches. In an example, the electric motor 301 can provide up to 5 Nm of torque.

The coupling components for the electric motor 301 include a shaft 302, which is rotated by the electric motor 301. A worm drive 304 is rigidly coupled to the shaft 302 and rotates therewith. The worm drive 304 engages a ring gear 306. The ring gear 306 has an annular geometry and defines a worm gear/thread 308 on its outer surface and an axial thread 310 on its inner surface. Rotation of the shaft 302 by the electric motor 301 rotates the worm drive 304 about the axis of the shaft 302. The worm drive 304 engages the worm gear 308 at a perpendicular angle to the axis of the ring gear 306, and the engagement between the worm drive 304 and the worm gear 308 rotates the ring gear about an axis extending through the center of its aperture. The axial thread 310 on the inner surface of the ring gear 306 engages a corresponding axial thread 312 on an outer surface of the restrictor ring 104. The restrictor ring 104 has an annular geometry defining an aperture in a center thereof. When assembled on the separator 100, a nose of the auger 106 extends through the restrictor ring 104 and an output stream of product exits through the gap 102 defined between an inner surface 314 of the restrictor ring 104 and the auger 106. As discussed above, the restrictor ring 104 can include a wear plate on its inner surface 314 which provides a hard surface to resist wear from the product flowing past.

The axial thread 312 on the outer surface of the restrictor ring 104 is engaged by the axial thread 310 of the ring gear 306. The axial threads 310, 312 extend axially around their respective surfaces. As the ring gear 306 is rotated axially by the worm drive 304, the engagement of the axial threads 310, 312 pushes the restrictor ring 104 to translate along an axis through the center of its aperture. Keyed portions 316 of the restrictor ring 104 which engage corresponding detents 318 in a housing plate 320 prevent the restrictor ring 104 from rotating once the adjustment assembly 300 is assembled. Any appropriate thread profiles can be used for the respective threads. In an example, the worm gear 308 has an ACME thread profile. The adjustment assembly 300 also include other housing, gasket, and fastener components to complete the assembly 300. These other components are not described herein in detail and can be included as desired by those skilled in the art.

The example coupling assembly shown and described herein provides a means for the electric motor 301 to translate the restrictor ring 104 about an axis extending through the center of the aperture and thereby adjust the width of the gap 102. In other examples, other restrictor rings or coupling components can be used to transfer power from the electric motor to the restrictor ring 104. Providing powered translation of the restrictor ring 104 eliminates the difficulty of manually turning a nut or the like to translate the restrictor ring 104.

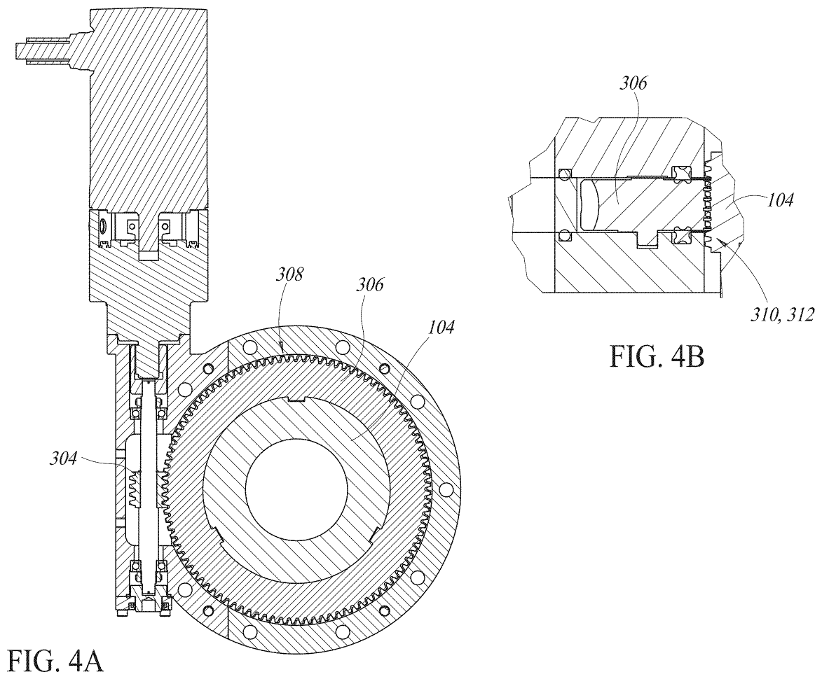

FIG. 4A is a cross-sectional view of the adjustment assembly 300 showing the worm drive 304 engaged with the worm gear 308 of the ring gear 306. Rotation of the worm drive 304 causes corresponding rotation of the ring gear 306, which in turn causes movement of the restrictor ring 104 as described above. FIG. 4B is an enlarged cross-sectional view of the adjustment assembly 300 showing the axial thread 310 of the ring gear 306 engaged with the axial thread 312 of the restrictor ring 104.

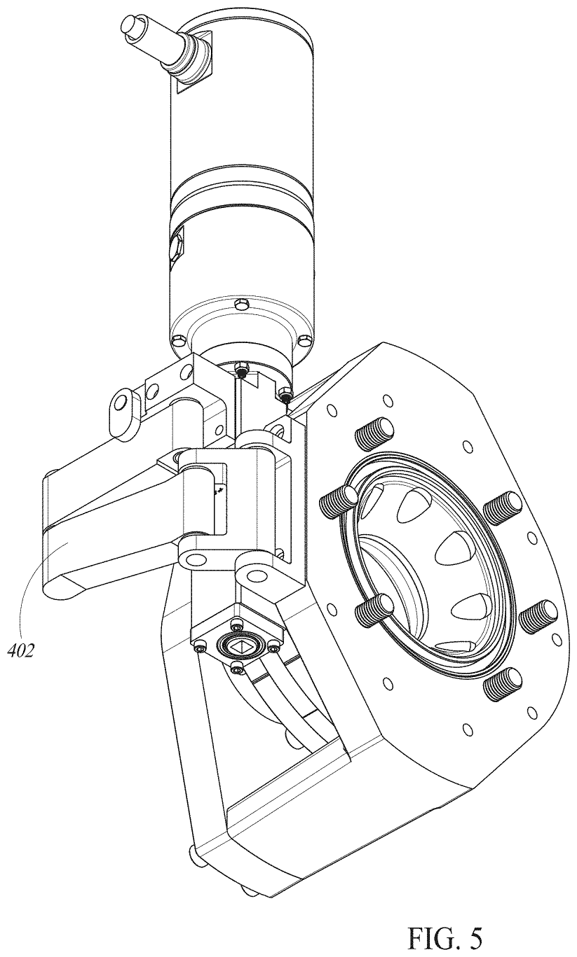

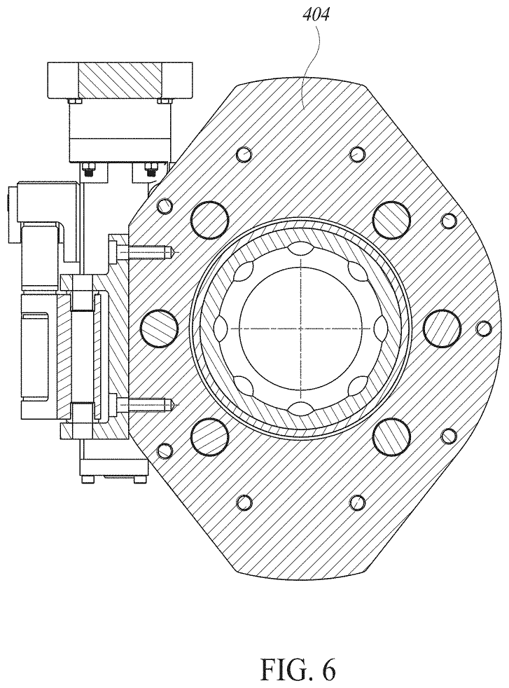

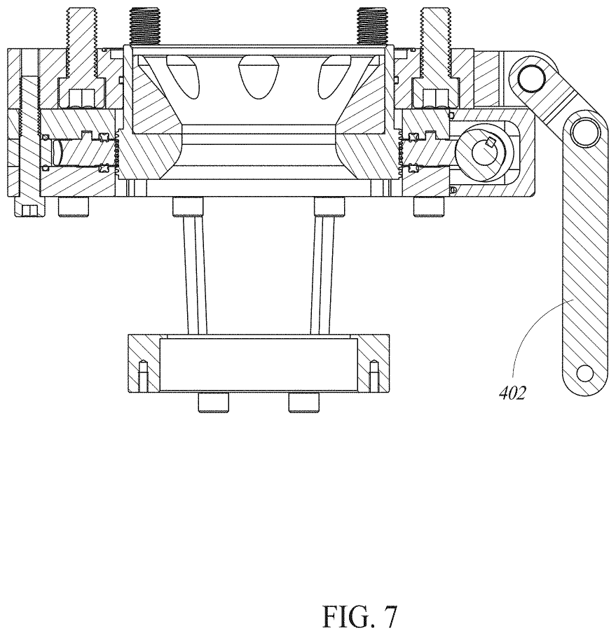

FIGS. 5, 6, and 7 includes various views of the example adjustment assembly 300. As shown, the adjustment assembly 300 includes an arm 402 that connects between the adjustment assembly 300 and a frame of the separator 100. The arm 402 supports the adjustment assembly 300 enabling the mounting face 404 of the adjustment assembly 300 to be disconnected from the separator 300 and swung away from the separator 300 via the arm 402 hinges. The arm 402 enables easier disconnection of the adjustment assembly 300 from the rest of the separator 100 and access to the restrictor ring 104 for replacement, cleaning, or inspection thereof.

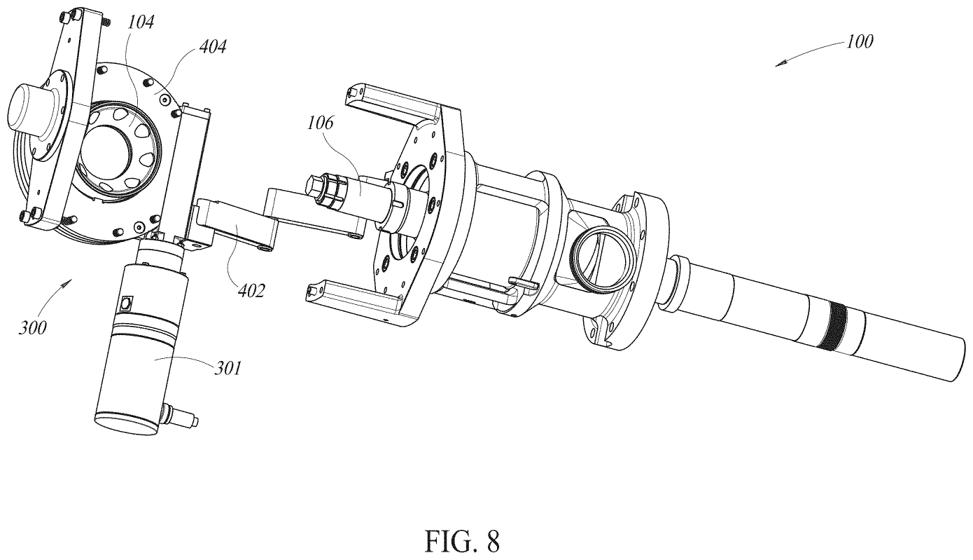

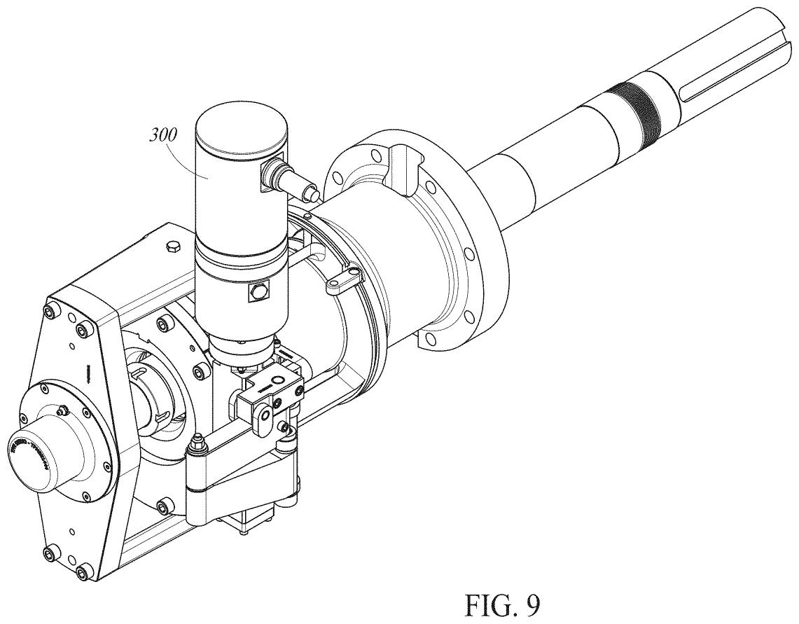

FIGS. 8 and 9 are perspective views of the example adjustment assembly 300 with the mounting face 404 disconnected from the separator 100 and hinged away from the separator 100. Only a portion of the separator 100 is shown for clarity. FIG. 9 is a perspective view of the example adjustment assembly 300 attached to the portion of the separator 100.

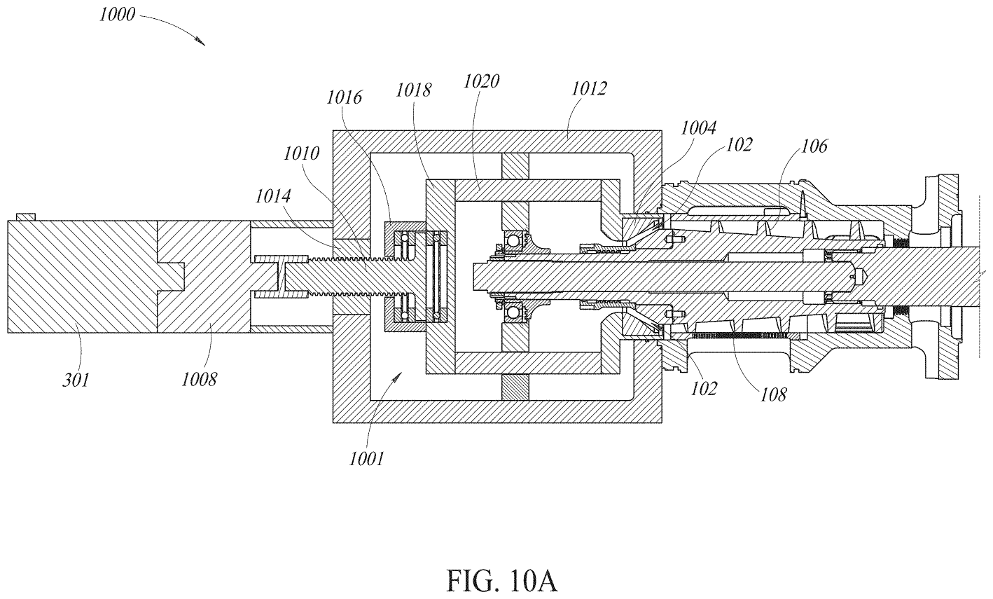

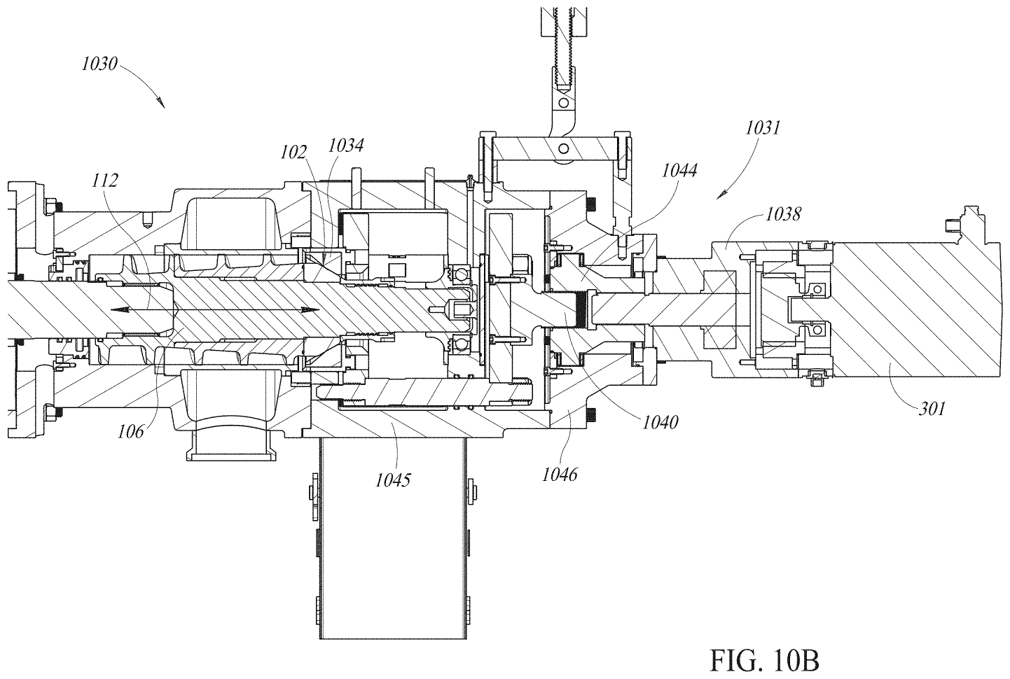

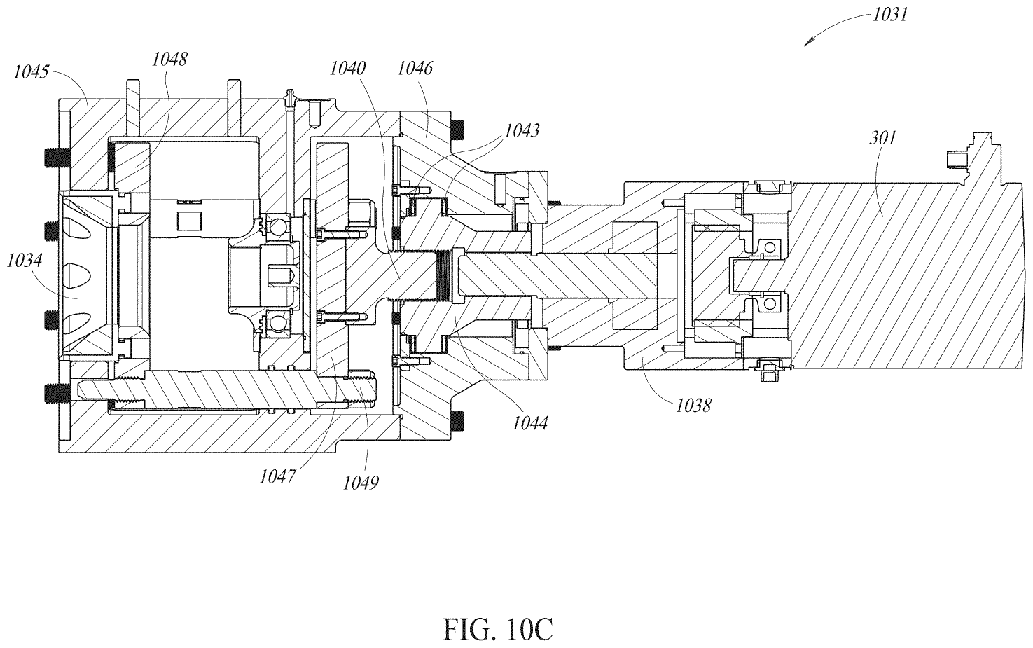

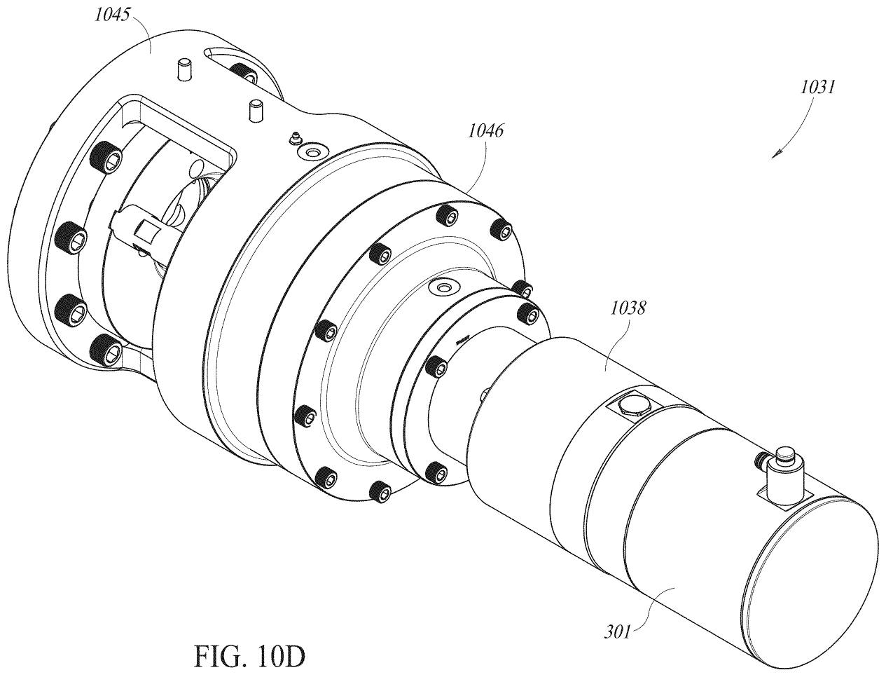

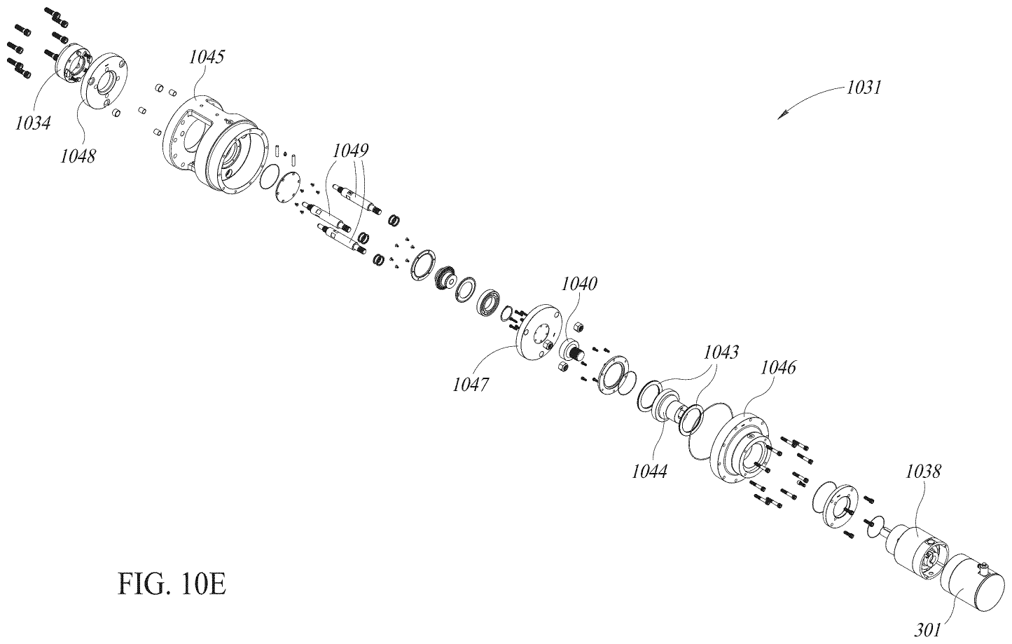

FIG. 10A is a cross-sectional view of an example separator 1000 with another example powered adjustment assembly 1001 that can adjust the position of a restrictor ring 1004 to change a width of a gap 102 in a separator 1000. The separator 1000 of FIG. 10A is similar to the separator 100 of FIG. 1 with the exception of the powered adjustment assembly 1001.

The powered adjustment assembly 1001 moves the restrictor ring 1004 axially with respect to the auger 106 to change the width of the gap 102. The powered adjustment assembly 1001 includes an electric motor 301 with a planetary gearbox 1008 coupled thereto. One end of a leadscrew 1010 is coupled to the planetary gearbox 1008 with a shaft coupling 1010 such that the electric motor 301 can rotate the leadscrew 1010 via coupling of the planetary gearbox 1008. The threads of the leadscrew 1010 are engaged with mating threads of a leadscrew nut 1014 that is attached to an assembly housing 1012, which is mounted to a body of the separator 1000. This coupling between the leadscrew 1010 and the leadscrew nut 1014 causes the leadscrew 1010 to translate axially in response to rotation of the leadscrew 1010 threads against the stationary leadscrew nut 1014. The opposite end of the leadscrew 1010 is coupled to a thrust bearing assembly 1016, which translates the axial translation of the leadscrew 1010 to a yoke 1018 and in turn to one or more tie bars 1020. The tie bars 1020 extend parallel to and alongside the auger and are attached to the restrictor ring 1004, to transfer the translation of the leadscrew 1010 into movement of the restrictor ring 1004 in the same distance and direction as the movement of the leadscrew 1010. The components of the assembly 1000, including the yoke 1018 and the tie bar(s) 1020 can have any appropriate size or geometry. Mechanical advantage is provided by the planetary gearbox 1008 and the leadscrew 1010.

FIG. 10B is a cross-sectional view of an example separator 1030 with another example powered adjustment assembly 1031 that can adjust the position of a restrictor ring 1034 to change a width of a gap 102 in the separator 1030. FIGS. 10C-E are a perspective, a cross-sectional, and an exploded view of the powered adjustment assembly 1031 disconnected from, and configured to mount to, a body of the separator 1030. The powered adjustment assembly 1031 of FIGS. 10B-E is similar to the powered adjustment assembly 1001 of FIG. 10A in that an electric motor 301 drives a leadscrew nut 1044 to cause axial movement of a leadscrew 1040 that is coupled to restrictor ring 1034.

The powered adjustment assembly 1031 moves the restrictor ring 1034 axially with respect to the auger 106 to change the width of the gap 102. As mentioned above, the powered adjustment assembly 1031 includes an electric motor 301 with a planetary gearbox 1038 coupled thereto. A leadscrew nut 1044 is coupled to the planetary gearbox 1038 such that the electric motor 301 can rotate the leadscrew nut 1044 via coupling of the planetary gearbox 1038. The planetary gearbox 1038 provides mechanical advantage by translating the input rotation of the shaft of the electric motor 301 into a different rate output rotation of the leadscrew nut 1040. The threads of the leadscrew nut 1044 are engaged with mating threads of a leadscrew 1040. This coupling between the leadscrew nut 1044 and the leadscrew 1040 causes the leadscrew 1040 to translate axially in response to rotation of the leadscrew nut 1044. The axial translation is with respect to the axis of rotation 112 of the auger 102 of the separator 1030. In an example the leadscrew 1040 and the leadscrew nut 1044 are aligned with the axis of rotation 112 of the auger 102 such that the leadscrew nut 1044 rotates about the axis of rotation 112. A thrust bearing assembly 1043 allows the leadscrew nut 1044 to rotate while being held in placed axially with respect to a housing that is mounted to a body of a separator 1030. The housing includes a main body 1045, which mounts on one end to a body of a separator 1030, and a cap 1046, which houses the leadscrew nut 1044 and mounts to the opposite end of the main body 1045.

The powered adjustment assembly 1031 also includes axial coupling components to couple the axial movement of the leadscrew 1040 to axial movement of the restrictor ring 1034. The axial coupling components translate the axial movement of the leadscrew 1040 to corresponding movement of the restrictor ring 1034, such that the restrictor ring 1034 moves axially in concert with the leadscrew 1040. That is, the translation of the leadscrew 1040 moves the restrictor ring 1034 the same distance and direction as the leadscrew 1040. The components of the assembly 1031 can have any appropriate size or geometry. In the example of FIGS. 10B-E, the axial coupling components include a yoke 1047 that mounts to the leadscrew 1040, a ring carrier 1048 that is coupled to the restrictor ring 1034, and a plurality of tie bars 1049 that connect to the ring carrier 1048 and the yoke 1047. The tie bars 1049 extend parallel to and alongside the auger 102 and are attached to the restrictor ring 1034 to transfer the translation of the leadscrew 1040 into movement of the restrictor ring 1034. The tie bars rigidly couple the restrictor ring 1034 to the leadscrew 1040, such that movement of the leadscrew 1040 causes the same distance and direction of movement to the restrictor ring 1034.

The adjustment assembly 1031 can also include other housings, gaskets, and fasteners and other components to complete the assembly 1031. These other components are not described herein in detail and can be included as desired by those skilled in the art.

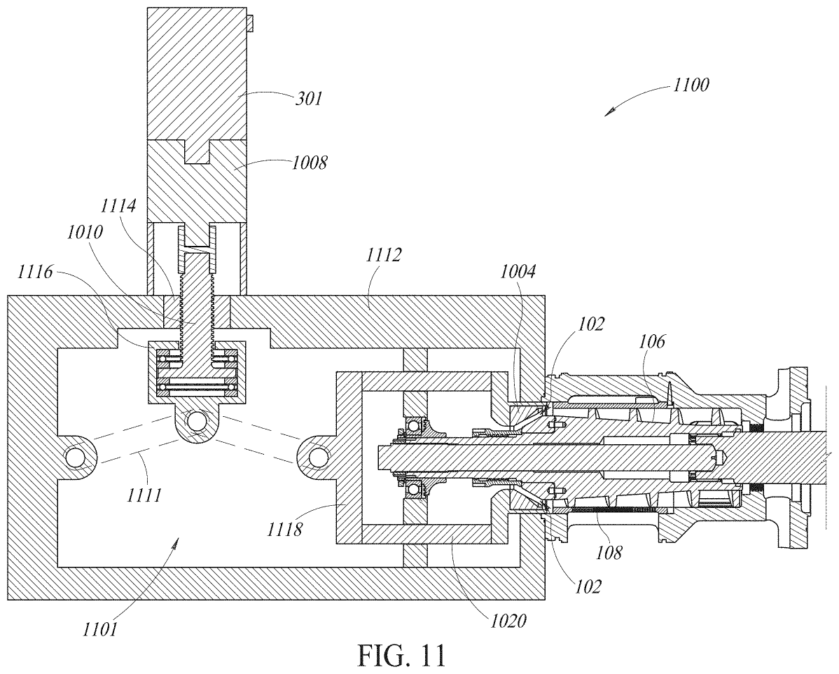

FIG. 11 is a cross-sectional view of an example separator 1100 with yet another example powered adjustment assembly 1101 that can adjust the position of a restrictor ring 1004 to change a width of a gap 102 in a separator 1100. The separator 1100 of FIG. 11 is similar to the separator 100 of FIG. 1 with the exception of the powered adjustment assembly 1101.

The powered adjustment assembly 1101 moves the restrictor ring 1004 axially with respect to the auger 106 to change the width of the gap 102. The powered adjustment assembly 1101 includes an electric motor 301, a planetary gearbox 1008, and a leadscrew 1010 similar to the adjustment assembly 1001 of FIG. 10. The threads of the leadscrew 1010 are engaged with mating threads of a leadscrew nut 1114 that is attached to a housing 1112 of the separator 1000. The nut 1114 is in a different location that the nut 1014 of FIG. 10 due to the coupling mechanism between the leadscrew 1010 and the tie bars 1020. Similar to FIG. 10, the coupling between the leadscrew 1010 and the leadscrew nut 1114 in FIG. 11 causes the leadscrew 1010 to translate axially in response to rotation of the leadscrew 1010 threads against the stationary leadscrew nut 1114. The opposite end of the leadscrew 1010 is coupled to a thrust bearing assembly 1116, which translates the axial translation of the leadscrew 1010 to a toggle joint mechanism 1111. The toggle joint mechanism 1111 includes a plurality of links with a joint therebetween to translate the axial movement of the leadscrew 1010 into movement of a yoke 1118 in a direction parallel with the axis of rotation of the auger 106. In this example, the axial movement of the leadscrew 1010 is in a direction normal to the axis of rotation of the auger 106, however, in other examples, the leadscrew 1010 can be disposed to move at other angles with respect to the auger 106. This movement of the yoke 1118 moves the tie bars 1020 which are attached to the restrictor ring 1004, such that the translation of the leadscrew 1010 moves the restrictor ring 1004 axially with respect to the auger 106. Mechanical advantage is provided by the planetary gearbox 1008, the leadscrew 1010 and the toggle joint mechanism 1111. For example, at an angle of α≤10° the toggle joint mechanism 1111 provides 2.84 or greater force multiplier, which continues to increase as α decreases.

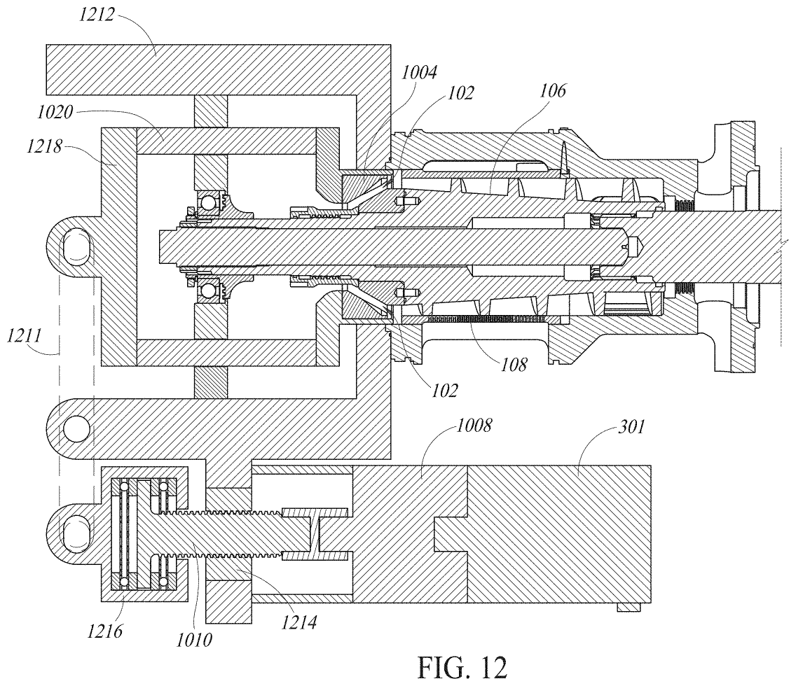

FIG. 12 is a cross-sectional view of an example separator 1200 with still another example powered adjustment assembly 1201 that can adjust the position of a restrictor ring 1004 to change a width of a gap 102 in a separator 1200. The separator 1200 of FIG. 12 is similar to the separator 100 of FIG. 1 with the exception of the powered adjustment assembly 1201.

The powered adjustment assembly 1201 moves the restrictor ring 1004 axially with respect to the auger 106 to change the width of the gap 102. The powered adjustment assembly 1201 includes an electric motor 301, a planetary gearbox 1008, and a leadscrew 1010 similar to the adjustment assembly 1001 of FIG. 10. The threads of the leadscrew 1010 are engaged with mating threads of a leadscrew nut 1214 that is attached to a housing 1212 of the separator 1200. The nut 1214 is in a different location that the nut 1014 of FIG. 10 due to the coupling mechanism between the leadscrew 1010 and the tie bars 1020. Similar to FIG. 10, the coupling between the leadscrew 1010 and the leadscrew nut 1214 in FIG. 12 causes the leadscrew 1010 to translate axially in response to rotation of the leadscrew 1010 threads against the stationary leadscrew nut 1214. The opposite end of the leadscrew 1010 is coupled to a thrust bearing assembly 1216, which translates the axial translation of the leadscrew 1010 to a lever mechanism 1211. The lever mechanism 1211 translates the axial movement of the leadscrew 1010 into movement of a yoke 1118 in a direction parallel with the axis of rotation of the auger 106. This movement of the yoke 1118 moves the tie bars 1020 which are attached to the restrictor ring 1004, such that the translation of the leadscrew 1010 moves the restrictor ring 1004 axially with respect to the auger 106. Mechanical advantage is provided by the planetary gearbox 1008, the leadscrew 1010 and the lever mechanism 1211. While a single class 1 lever is illustrated in FIG. 12, it is understood that any number of levers of class 1, 2, 3 or any combination could be employed.

The threads of the leadscrew 1010, 1040 of any of FIGS. 10A, 10B-E, 11, and 12 can be any power-transmitting or motion-control thread including trapezoidal, square, vee, ball, etc. The thrust bearing assemblies 1016, 1043, 1116, 1216 of FIGS. 10A, 10B-E, 11, and 12 isolate the rotational motion of the leadscrew 1010 or leadscrew nut 1044. Any number of bearings of any type can be use in the thrust bearing assemblies 1016, 1043, 1116, 1216, such as plain, ball, roller, etc. The powered adjustment assemblies 300, 1001, 1031, 1101, 1201 described herein must overcome the immense axial force produced by the auger 106 in order to adjust the width of the gap 102 during continuous operation of the separator 100, 1000, 1030, 1100, 1200. In order to develop the necessarily large opposing axial force on the restrictor ring 104, 1004 with an electric motor 301 of reasonable size mechanical advantage is provided by the adjustment assemblies 300, 1001, 1031, 1101, 1201 described herein. Any type of gearing may be used with the electric motor 301 alone or in combination with any of the mechanisms described herein.

In an example, the adjustment assemblies 300, 1001, 1031, 1101, 1201 is configured to be retrofit onto an existing separator. In such an example, the adjustment assembly 300, 1001, 1031, 1101, 1201 can be configured to be added with little or no change to the existing separator and its replaceable parts such that separator owners can use the adjustment assembly 300, 1001, 1031, 1101, 1201 with existing separators and part inventory. In other examples, the adjustment assembly 300, 1001, 1031, 1101, 1201 can be included on a new separator design.

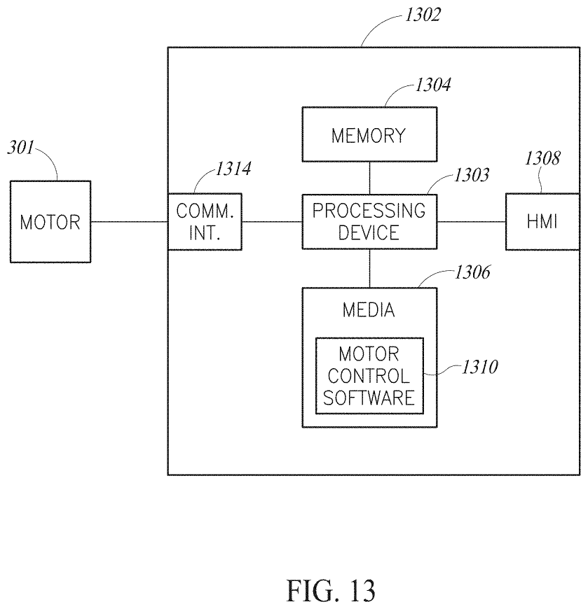

FIG. 13 is a block diagram of an example electric motor 301 which is coupled to a controller 1302 for controlling the operation thereof. The electric motor 301 in any of the separators 100, 1000, 1031, 1100, 1200 described herein can be wired or wirelessly communicatively coupled to an appropriate controller 1302 for controlling the operation of the electric motor 301. Any appropriate communicative coupling between the controller and electric motor 301 can be used such an analog or digital voltage signal. Also, any appropriate controller can be used such as a programmable logic controller (PLC) or general-purpose computer (e.g., Windows based).

The controller 1302 can include motor control software 1310 (computer readable instructions) thereon control operation of the electric motor 301, and in turn the position of the restrictor ring 104, 1004, 1034. The controller 1302 can include one or more processing devices 1303 to execute the instructions of the software 1310. The one or more processing devices 1303 can include a general-purpose processor or a special purpose processor. The instructions of the motor control software 1310 are stored (or otherwise embodied) on or in an appropriate storage medium or media 1306 (such as a flash or other non-volatile memory) from which the instructions are readable the processing device(s) 1302 for execution thereby. The controller 1302 also includes memory 1302 that is coupled to the processing device(s) 1303 for storing instructions (and related data) during execution by the processing device(s) 1303. Memory 1304 comprises, in one implementation, any suitable form of random-access memory (RAM) now known or later developed, such as dynamic random-access memory (DRAM). In other implementations, other types of memory are used. The instructions of the software 1310, when executed by the one or more processing devices 1303, cause the one or more processing devices 1303 to perform the actions (or a portion thereof) of the controller 1302 described herein.

The controller 1302 also includes a communication interface 1314 for sending commands to and receiving signals from the electric motor 301. The communication interface 1314 can be coupled to the one or more processing devices 1302. The communication interface 1314 can include wired or wireless interface.

The controller 1302 can also include one or more human machine interfaces (HMI) 1308 coupled to the one or more processing devices 1303 to receive commands from and provide information to a human operator. The one or more HMIs 1308 can include one or more of a keyboard, mouse, monitor (e.g., non-touch, or touch-screen), speaker, or other input/output device.

In operation, the controller 1302 can receive a command from an operator via the HMI 1304 to set the gap 102 at a certain setting. For example, the controller 1302 can receive a command to reduce the gap 102 by 5 thousandths of an inch. In response to the command, the controller 1302 can send appropriate signals to the electric motor 301 to translate the restrictor ring 104 five thousandths of an inch closer to the auger 106. Since the electric motor 301 can more easily move the restrictor ring 104, 1004, 1034 as opposed to a manual movement design, an adjustment by the electric motor 301 can be performed while the separator 301 is in continuous operation separating product. In any case, the controller 1302 can provide appropriate instructions to the electric motor 301 in response to commands received from an operator to translate the restrictor ring 104, 1004, 1034.

In an example, the software 1310 on the controller 1302 can include one or more routines that include a plurality of steps for to perform a desired action with the electric motor 301 and restrictor ring 104, 1004, 1034. A first routine can include a homing routine. The homing routine can be used to determine and set an absolute width (size) for the gap 102 between the restrictor ring 104 and the auger 110. Determining and setting an absolute width for the gap 102 can be performed after the separator 100, 1000, 1030, 1100, 1200 is rebuilt when the position of the components may have changed. The homing routine is intended to be performed when the separator 100, 1000, 1030, 1100, 1200 is clean and not in operation. In an example, the homing routine can request and receive a gap setting from an operator. The homing routine can start by commanding the electric motor 301 to translate the restrictor ring 104, 1004, 1034 towards the auger 106. The homing routine can translate the restrictor ring 104, 1004 towards the auger 106 until restrictor ring 104, 1004 contacts the auger 106. Once the restrictor ring 104, 1004, 1034 contacts the auger 106, the motor 301 stops moving the restrictor ring 104, 1004, 1034. At the point of contact between the restrictor ring 104, 1004, 1034 and the auger 106, the gap 102 is set to 0 thousandths of an inch. Thus, the software saves an indication that this is the 0 position for the current set-up of the separator 100, 1000, 1030, 1100, 1200. This zero position can be referenced for all future gap settings until a new 0 position is saved during a subsequent performance of the homing routine, for example, after a subsequent rebuild of the separator 100, 1000, 1030, 1100, 1200.

In an example, the controller 1302 receives an indication of the electrical current provided to power the motor 301 and the controller 1302 identifies contact between the restrictor ring 104, 1004, 1034 and the auger 106 by identifying a current rise in the power provided to the electric motor 301. When the restrictor ring 104, 1004, 1034 initially comes into contact with the auger 106, the motor 301 will still be trying to translate the restrictor ring 104, 1004, 1034 but will no longer be able to do so. This will cause a rise in the current powering the motor 301. This rise can be sensed by the controller 1303 and in response to sensing the current rise by the controller 1302 can send a signal to stop the motor 301. In an example, the controller 1302 commands the motor 301 such that the restrictor ring 104, 1004, 1034 is translated slowly during the homing routine to provide more time for the controller 1302 to sense the current rise and stop the motor 301.

Once the zero position is set, the controller 1302 can command the motor 301 to translate the restrictor ring 104, 1004, 1034 in the opposite direction, away from the auger 106 to set the gap 102 at the distance received from the operator. In an example, the motor 301 can provide feedback to the controller 1302 indicating precisely how much its shaft rotates during its movement. The software 1310 on the controller 1302 can include a translation algorithm that translates the amount of rotation of the motor shaft to an amount of movement (translation) of the restrictor ring 104, 1004, 1034. The translation algorithm is based on the gear ratio between the electric motor 301 and the restrictor ring 104, 1004, 1034. In an example, the worm drive 304 and the worm gear 308 of the adjustment assembly 300 provide a 100 to 1 gear ratio and a planetary gear box coupled to the electric motor 301 that provides a 10 to 1 gear ratio. The translation algorithm can be an equation, a table, or other appropriate conversion means. In any case, while the motor 301 is moving the restrictor ring 104, 1004, 1034 away from the auger 106, the controller 1302 tracks how far the restrictor ring 104, 1004, 1034 has moved via the feedback from the motor 301 or other feedback device and the translation algorithm. The controller 1302 moves the restrictor ring 104, 1004, 1034 from the zero point until the restrictor ring 104, 1004, 1034 is at the location of the desired gap width (e.g., 15 thousandths of an inch). Once the restrictor ring 104, 1004, 1034 is at the location of the desired gap width the controller 1302 sends a signal to the motor 301 to stop the restrictor ring 104, 1004, 1034. The desired gap 102 is now set for operation of the separator 100, 1000, 1030, 1100, 1200.

Advantageously, the homing routine enables an operator to know exactly what the current gap width is. Since the homing routine determines the zero point, the current gap width is known based on the amount of movement from the zero point. The controller 1302 can output the current gap width to an operator via the HMI 1308 for reference by the operator or to another system (e.g., control system) such that the other system can use the information as desired (e.g., as a control variable). Moreover, subsequent adjustments of the gap 102 can also be performed and result in an absolute known position. During a subsequent adjustment, the controller 1302 can command the restrictor ring 104, 1004, 1034 to translate towards or away from the auger 106 as desired and can track the amount of movement from the current position based on the feedback from the motor 301 and the translation algorithm. In this way, once the homing routine has been performed the absolute gap width can be known for all future gap settings. This provides precise and repeatable gap widths for each run and adjustment of the separator 100, 1000, 1030, 1100, 1200.

In an example, the translation algorithm can include a backlash offset which allows the motor shaft to rotate a set amount in certain situations before the translation algorithm accounts the motor shaft rotation to movement of the restrictor ring 104, 1004, 1034. Since there may be some amount of play in the gears/threads of the coupling components, the initial movement of the motor shaft in certain situations may be taken up by the play in the gears and no movement of the restrictor ring 104, 1004, 1034 will occur. The translation algorithm can account for this lack of movement with a gear backlash offset. The gear backlash offset can be incorporated into the algorithm by causing the translation algorithm to not attribute the initial ‘Z’ amount of rotation of the motor shaft to movement of the restrictor ring 104, 1004, 1034 wherein ‘Z’ is the amount of rotation of the gear backlash offset.

In an example, the translation algorithm can apply the gear backlash offset each time the restrictor ring 104, 1004, 1034 is moved in a direction opposite from its last move. Thus, if the restrictor ring 104, 1004, 1034 was last moved away from the zero point (auger 106) and the restrictor ring 104, 1004, 1034 is now to be moved towards the zero point, the translation algorithm applies the gear backlash offset to essentially ignore the first ‘Z’ amount of rotation of the motor shaft. Such a configuration could be used to account for the play in the gears when switching directions. The gear backlash offset would not be applied in such a configuration when the last movement was in the same direction as the current movement. The gear backlash offset can be applied within a routine, such as within the homing routine discussed above.

In an example, the coupling components in the adjustment assembly 300, 1001, 1031, 1101, 1201 for the restrictor ring 104, 1004, 1034 act to lock the restrictor ring 104, 1004, 1034 in place when the adjustment assembly 300, 1001, 1031, 1101, 1201 is not being moved by the motor 301. During operation of the separator 100, 1000, 1030, 1100, 1200 significant force can be placed on the restrictor ring 104, 1004, 1034 pushing the restrictor ring 104, 1004, 1034 away from the auger 106. The contact between threads of the adjustment assembly 300, 1001, 1031, 1101, 1201, however, provides resistance to translation of the restrictor ring 104, 1004, 1034 when it is not being moved by the motor 301. In some examples, the motor 301 can also apply a holding torque to ensure the worm drive 304 is not rotated due to force on the restrictor ring 104, 1004 during operation of the separator 100, 1000, 1030, 1100, 1200. In an example, the holding torque can be applied by an integrated or separately coupled electro-mechanical braking device. Additionally, the locking between the threads and/or holding torque can reduce or prevent “burping” of the separator 100, 1000, 1030, 1100, 1200 in which the restrictor ring 104, 1004, 1034 is forced away from the auger 106 temporarily by a large hard item in the product flow.

In an example, the software 1310 can provide a minimum setting and a maximum setting for the gap 102. The minimum setting can be used to ensure the gap 102 is not set too small by an operator, which could cause damage to the restrictor ring 104, 1004, 1034 and/or auger nose cone. The minimum setting can set at any desired distance, such as 5 thousandths of an inch. The maximum setting can be used to ensure the gap 102 is not set too large by an operator, which could result in the restrictor ring being unthreaded from the ring gear. The software can ensure the gap 102 is not set to a distance below the minimum setting for operation.

In an example, the software 1310 can provide a full open routine. The full open routine can set the gap 102 at a desired maximum distance. In an example, the maximum distance is 250 thousandths of an inch. The software 1310 can implement the full open routine in response to a command from an operator via the HMI 1308 to set to full open. In an example, the software 1310 can also be in communication with other control software for the separator 100, 1000, 1030, 1100, 1200 and/or a larger system in which the separator 100, 1000, 1030, 1100, 1200 operates. The software can implement the full open routine in response to an indication from the other control software indicating an emergency, immediate stop, or shut down situation.

In an example, the software 1310 can implement an automatic gap control routine. The automatic gap control routine can dynamically adjust the gap 102 based on feedback from the product flow through the separator 100, 1000, 1030, 1100, 1200. In such an example, the software 1310 can receive feedback signals or indications from other software regarding process variables for the product flow through the separator 100. The software 1310 can analyze the current process variables in real time and dynamically adjust the gap 102 to drive the process variables towards desired settings. Any appropriate process variables can be used including any one or more of a moisture level of the product flow that is pressed through the screen 108, a moisture level of the product flow that passes through the gap 102, a percentage of the product flow exiting through the gap 102 that is calcium, a percentage of the product flow passing through the screen 108 that is calcium, a weight ratio between the flow pressed through the screen and the flow exiting through the gap 102, and/or other process variables.

Although example dimensions are shown in the drawings herein, it should be understood that other dimensions can also be used. In other example, the routines described herein can be used on other separator designs to control/set the width of the restrictor gap that allows product not pushed through the screen to exit the separator.

What is claimed is:

1. An adjustment assembly for adjusting a gap between a restrictor ring and an auger in an industrial food separator, the adjustment assembly comprising:
an electric motor having a shaft;
a mechanical assembly coupling the electric motor to the restrictor ring to translate rotation of a shaft of the electric motor into movement of the restrictor ring to change a width of the gap, the mechanical assembly including:
a leadscrew extending in a direction parallel with an axis of rotation of the auger, the leadscrew defining first threads on an exterior facing surface thereof;
a leadscrew nut defining second threads on an interior facing surface thereof, the second threads of the leadscrew nut engaged with the first threads of the leadscrew, wherein the leadscrew and the leadscrew nut interact with one another such that one of the leadscrew or leadscrew nut is a rotating member and the other of the leadscrew or leadscrew nut is an axially translating member, the rotating member coupled to the shaft of the electric motor such that rotation of the shaft rotates the rotating member, wherein the rotating member of the leadscrew or leadscrew nut is restricted from axial movement along the axis of rotation of the auger, such that rotation of the rotating member causes axial movement of the axially translating member along the axis of rotation of the auger; and
axial coupling components coupling the axial movement of the axially translating member to corresponding axial movement of the restrictor ring; and
a controller communicatively coupled to the electric motor, the controller having one or more processing devices, a memory coupled to the one or more processing devices, and storage media, wherein the storage media has instructions stored thereon, the instructions, when executed by the one or more processing devices, cause the one or more processing devices to send commands to the electric motor to move the restrictor ring to change a width of the gap.

2. The adjustment assembly of claim 1, further comprising:
a gearbox coupled between the shaft of the electric motor and the rotating member, the gearbox configured to convert input rotation of the shaft of the electric motor to a different rate output rotation of the rotating member.

3. The adjustment assembly of claim 1, wherein the leadscrew is the rotating member coupled to the shaft of the electric motor and the leadscrew nut is the translating member and is attached to a housing such that rotation of the leadscrew with respect to the leadscrew nut causes the leadscrew to translate along the axis of rotation of the auger.

4. The adjustment assembly of claim 3, wherein the axial coupling components include:
a thrust bearing assembly coupled to the leadscrew; and
one or more tie bars extending parallel to and alongside the auger to couple the thrust bearing assembly to the restrictor ring.

5. The adjustment assembly of claim 1, wherein the leadscrew nut is the rotating member coupled to the shaft of the electric motor and the leadscrew is the translating member, wherein the leadscrew nut is restricted from axial movement along the axis of rotation of the auger by a thrust bearing assembly such that rotation of the leadscrew nut with respect to the leadscrew causes the leadscrew to translate along the axis of rotation of the auger.

6. The adjustment assembly of claim 5, wherein the axial coupling components include:
one or more tie bars extending parallel to and alongside the auger to couple the leadscrew to the restrictor ring.

7. The adjustment assembly of claim 1, wherein the instructions cause the one or more processing devices to:
set the gap at a desired width wherein set the gap at a desired width includes:
move the restrictor ring to decrease the gap until the restrictor ring contacts the auger; and
in response to the restrictor ring contacting the auger, move the restrictor ring to increase the gap until the restrictor ring has moved an amount equal to the desired width.

8. The adjustment assembly of claim 7, wherein set the gap at a desired width includes:
identify an increase in current to the electric motor that corresponds to the restrictor ring contacting the auger; and
in response to the restrictor ring contacting the auger, rotate the shaft of the electric motor in a direction to increase the gap and for an amount corresponding to the restrictor ring having moved an amount equal to the desired width.

9. The adjustment assembly of claim 1, wherein the instructions cause the one or more processing devices to include additional movement when commanding rotation of the shaft of the electric motor that causes a change in direction from a most recent movement of the restrictor ring to account for gear backlash in the adjustment assembly.

10. The adjustment assembly of claim 1, wherein the instructions cause the one or more processing devices to limit a gap setting to larger than a minimum width.

11. The adjustment assembly of claim 1, wherein the instructions cause the one or more processing devices to automatically adjust the gap in response to process variable information received from a system monitoring product flow through the separator.

12. The adjustment assembly of claim 11, wherein the process variable information includes one or more of:
a moisture level of at least one of a first or a second product flow exiting the separator, wherein the first product flow is a product flow that is pressed through a screen of the separator and the second product flow is a product flow that passes through the gap;
a percentage of at least one of the first or the second product flow exiting the separator that is calcium; and
a weight ratio between the first product flow and the second product flow.

13. An industrial screw separator comprising:
a housing defining a separation chamber, the separation chamber defined at least in part by a screen;
an auger extending through the separation chamber;
a restrictor ring disposed to define a gap between the restrictor ring and the auger, wherein the auger is configured to force product in the separation chamber against the screen and towards the gap to produce a first output flow of product that has been pressed through the screen and a second output flow of product that passes through the gap;
an adjustment assembly configured to move the restrictor ring and adjust a width of the gap, the adjustment assembly comprising:
an electric motor having a shaft;
a mechanical assembly coupling the electric motor to the restrictor ring to translate rotation of a shaft of the electric motor into movement of the restrictor ring to change a width of the gap, the mechanical assembly including:
a leadscrew extending in a direction parallel with an axis of rotation of the auger, the leadscrew defining first threads on an exterior facing surface;
a leadscrew nut defining second threads on an interior facing surface, the second threads of the leadscrew nut engaged with the first threads of the leadscrew, wherein the leadscrew and the leadscrew nut interact with one another such that one of the leadscrew or leadscrew nut is a rotating member and the other of the leadscrew or leadscrew nut is an axially translating member, the rotating member coupled to the shaft of the electric motor such that rotation of the shaft rotates the rotating member, wherein the rotating member of the leadscrew or leadscrew nut is restricted from axial movement along the axis of rotation of the auger, such that rotation of the rotating member causes axial movement of the axially translating member along the axis of rotation of the auger; and
axial coupling components coupling the axial movement of the axially translating member to corresponding axial movement of the restrictor ring; and
a controller communicatively coupled to the electric motor, the controller having one or more processing devices, a memory coupled to the one or more processing devices, and storage media, wherein the storage media has instructions stored thereon, the instructions, when executed by the one or more processing devices, cause the one or more processing devices to send commands to the electric motor to move the restrictor ring to change a width of the gap.

14. The separator of claim 13, further comprising:
a gearbox coupled between the shaft of the electric motor and the rotating member, the gearbox configured to convert input rotation of the shaft of the electric motor to a different rate output rotation of the rotating member.

15. The separator of claim 13, wherein the leadscrew is the rotating member coupled to the shaft of the electric motor and the leadscrew nut is the translating member and is attached to a housing such that rotation of the leadscrew with respect to the leadscrew nut causes the leadscrew to translate along the axis of rotation of the auger.

16. The separator of claim 15, wherein the axial coupling components include:
a thrust bearing assembly coupled to the leadscrew; and
one or more tie bars extending parallel to and alongside the auger to couple the thrust bearing assembly to the restrictor ring.

17. The separator of claim 13, wherein the leadscrew nut is the rotating member coupled to the shaft of the electric motor and the leadscrew is the translating member, wherein the leadscrew nut is restricted from axial movement along the axis of rotation of the auger by a thrust bearing assembly such that rotation of the leadscrew nut with respect to the leadscrew causes the leadscrew to translate along the axis of rotation of the auger.

18. The separator of claim 17, wherein the axial coupling components include:
one or more tie bars extending parallel to and alongside the auger to couple the leadscrew to the restrictor ring.

19. The separator of claim 13, wherein the instructions cause the one or more processing devices to automatically adjust the gap in response to process variable information received from a system monitoring product flow through the separator.

20. The separator of claim 19, wherein the process variable information includes one or more of:
a moisture level of at least one of the first or second output flow;
a percentage of at least one of the first or second output flow that is calcium; and
a weight ratio between the first output flow and the second output flow.
